(19) United States
(12) Patent Application Publication
(10) Pub. No.: US 2015/0338678 A1
(43) Pub. Date: Nov. 26, 2015

(54) Modular Eyewear Apparatus

(71) Applicants: Francis Gerard Fafaul, San Diego, CA (US); Gracia H. C. Brentlinger, Lakeside, CA (US)

(72) Inventors: Francis Gerard Fafaul, San Diego, CA (US); Gracia H. C. Brentlinger, Lakeside, CA (US)

(21) Appl. No.: 14/719,965

(22) Filed: May 22, 2015

Related U.S. Application Data
(60) Provisional application No. 62/001,718, filed on May 22, 2014.
(60) Provisional application No. 62/007,120, filed on Jun. 3, 2014.

(51) Int. Cl. G02C 5/14; G02C 1/06

(52) U.S. Cl. CPC G02C 5/146; G02C 1/06

(57) ABSTRACT

A modular eyewear apparatus includes a frame member having left and right socket portions each having a generally circular rim defining an interior void, respectively, and being connected by a bridge portion, the left and the right socket portion having a temple connector extending rearwardly from a respective rim. A lens holding member has a pair of adjacent rim sections selectively coupled to the rims of the left and the right socket portions, respectively. The eyewear apparatus includes proximal and distal ends, respectively, each proximal end being selectively coupled to a respective temple connector such that the temple members are interchangeable. The configurations of the selected members themselves enable them to be quickly and efficiently released from an assembly or to be interchangeably arranged into a new assembly as described above.

### REFERENCE TO RELATED APPLICATIONS

This application claims the benefit of provisional patent application U.S. Ser. No. 62/001,718 filed May 22, 2014 titled Exchangeable Eyewear Temples and U.S. Ser. No. 62/007,120 filed Jun. 3, 2014 titled Exchangeable Lenses In Eyewear which is incorporated herein by reference.

### BACKGROUND OF THE INVENTION

1. Field of the Invention

This invention relates to eyewear fashion and the mechanics surrounding the connectors that connect the eyewear lenses or temples to the eyewear frame.

2. Related Art

The current eyewear industry limits the creative voice of the eyewear and sunglass consumer by producing pre-designed eyewear. Choices regarding eyeglasses frames, lenses, temples, etc. are usually selected under the supervision of an optometrist. If a consumer wishes to have eyewear that is different than the eyewear he currently has, then he must go to his eyewear professions (e.g. a optometrist) and pick out a new pair of glasses. The user has not previously been able to easily customize or change the appearance of his eyewear on his own. Therefore, what is needed is a flexible connecting device (locking/releasing) that allows the consumer to exchange the lenses and/or temples on eyewear (e.g., spectacles, eyeglasses, sunglasses, etc.) to overcome the problems found in the art as described above.

Therefore, it would be desirable to have a single pair of glasses and/or sunglasses and still have the ability to change the look of the glasses. Further, it would be desirable to have a modular eyewear apparatus that gives the option to easily remove and interchange the lenses and temples using dynamic connectors.

### SUMMARY OF THE INVENTION

A modular eyewear apparatus according to the present invention includes a frame member having left and right socket portions each having a generally circular rim defining an interior void, respectively, and being connected by a bridge portion, the left and the right socket portion having a temple connector extending rearwardly from a respective rim. A lens holding member has a pair of adjacent rim sections selectively coupled to the rims of the left and the right socket portions, respectively. The eyewear apparatus includes proximal and distal ends, respectively, each proximal end being selectively coupled to a respective temple connector such that the temple members are interchangeable.

Therefore, a general object of this invention is to provide a modular eyewear apparatus that enables a person to change the temples, faceframe, and lenses of an eyewear apparatus, such as to customize the aesthetic appearance of a pair of glasses.

Another object of this invention is to provide a modular eyewear apparatus, as aforesaid, having a locking/releasing structure that enables a quick interchange of the temples of the eyewear.

Still another object of this invention is to provide a modular eyewear apparatus, as aforesaid, having a receptor and receptor channel construction that enables lens members to be selectively coupled to an eyeglasses frame member.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a front perspective view of a modular eyewear apparatus according to a preferred embodiment of the present invention;

FIG. 1b is a rear perspective view of the apparatus as in FIG. 1;

FIG. 2a is an exploded view of the apparatus as in FIG. 1a;

FIG. 3a is an exploded view of the apparatus as in FIG. 1b;

FIG. 3b is an isolated view on an enlarged scale taken from FIG. 3a;

FIG. 3c is an isolated view on an enlarged scale taken from FIG. 3a;

FIG. 3d is an isolated view on an enlarged scale taken from FIG. 3a;

FIG. 3e is an isolated view on an enlarged scale taken from FIG. 3a;

FIG. 4a is an exploded view of the apparatus as in FIG. 1a;

FIG. 4b is an isolated view on an enlarged scale taken from FIG. 4a;

FIG. 4c is an isolated view on an enlarged scale taken from FIG. 4a;

FIG. 5a is a front perspective view of a modular eyewear apparatus according to another embodiment of the present invention;

FIG. 5b is a partially exploded view of the apparatus as in FIG. 5a;

FIG. 5c is an isolated view on an enlarged scale taken from FIG. 5b;

FIG. 5d is an isolated view on an enlarged scale taken from FIG. 5b;

FIG. 6a is a side view of the modular eyewear apparatus as in FIG. 5a;

FIG. 6b is a sectional view taken along line 6b-6b of FIG. 6a;

FIG. 6c is an isolated view on an enlarged scale taken from FIG. 6b;

FIG. 6d is an isolated view on an enlarged scale taken from FIG. 6b; and

FIG. 6e is an isolated view on an enlarged scale taken from FIG. 6b.

### DESCRIPTION OF THE PREFERRED EMBODIMENT

Certain embodiments as disclosed herein provide for the easy exchange of the lenses on eyewear, with a locking/releasing connector that connects lenses to the eyewear frame. In specific exemplary embodiments, the eyewear connecting devise located on the lenses and the frame of the eyewear allows for the easy exchange of the lenses on any eyewear frame, with a locking/releasing connector that will connect lenses to different eyewear frames.

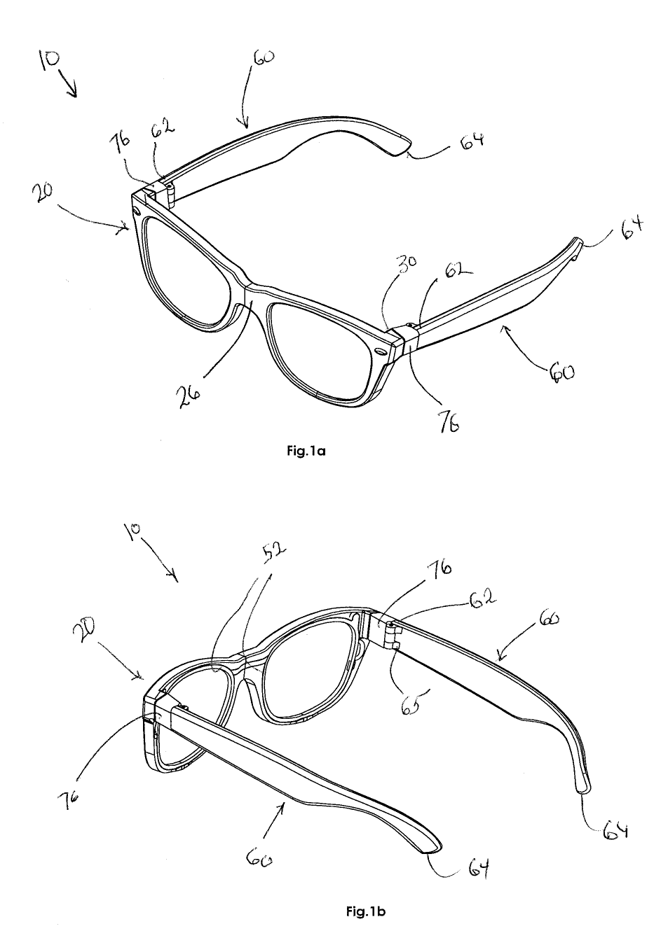

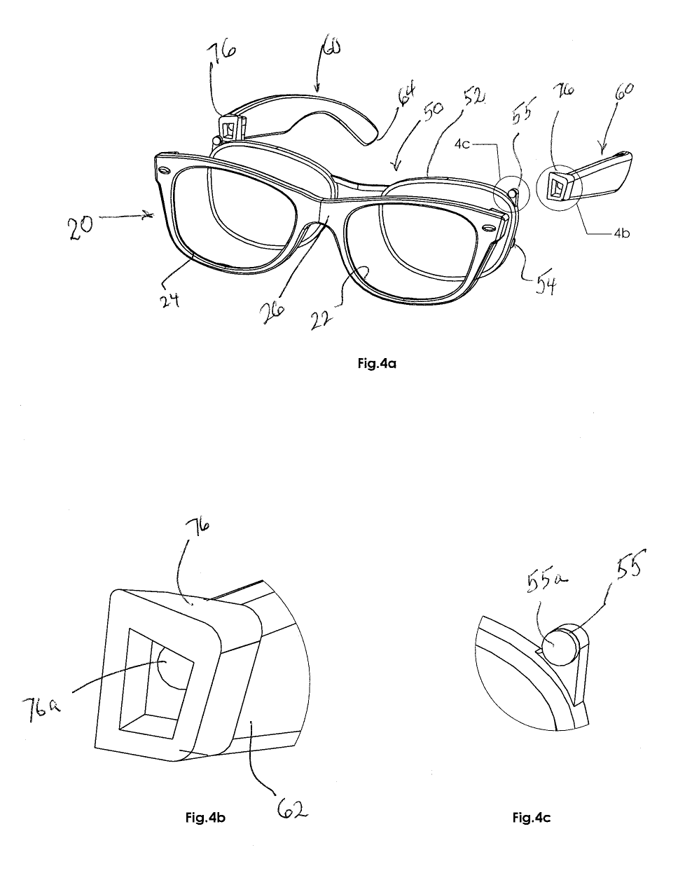

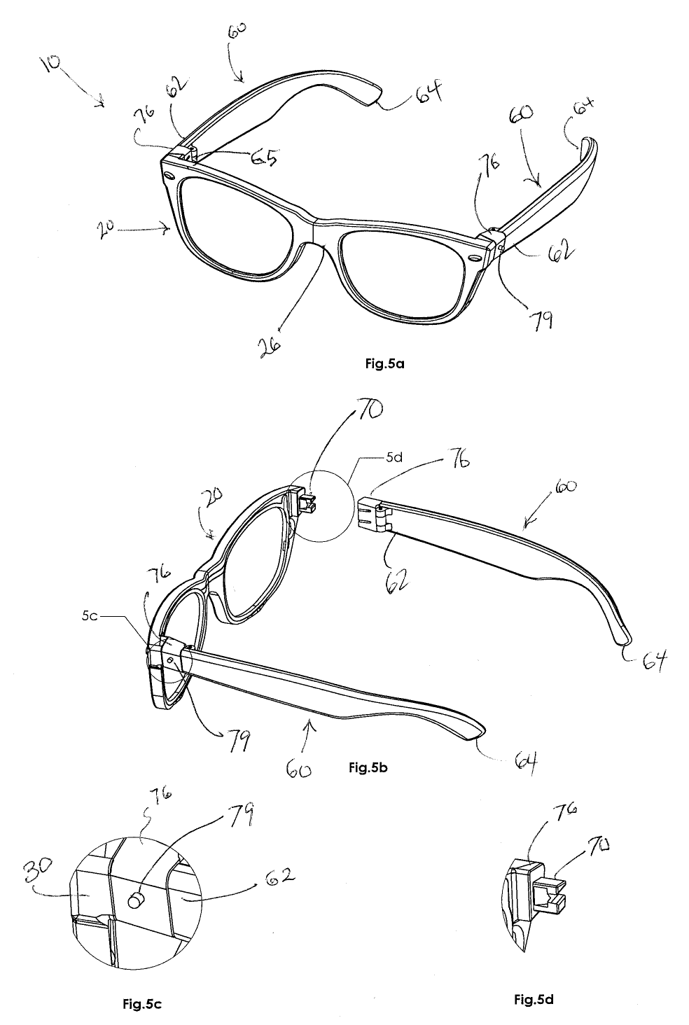

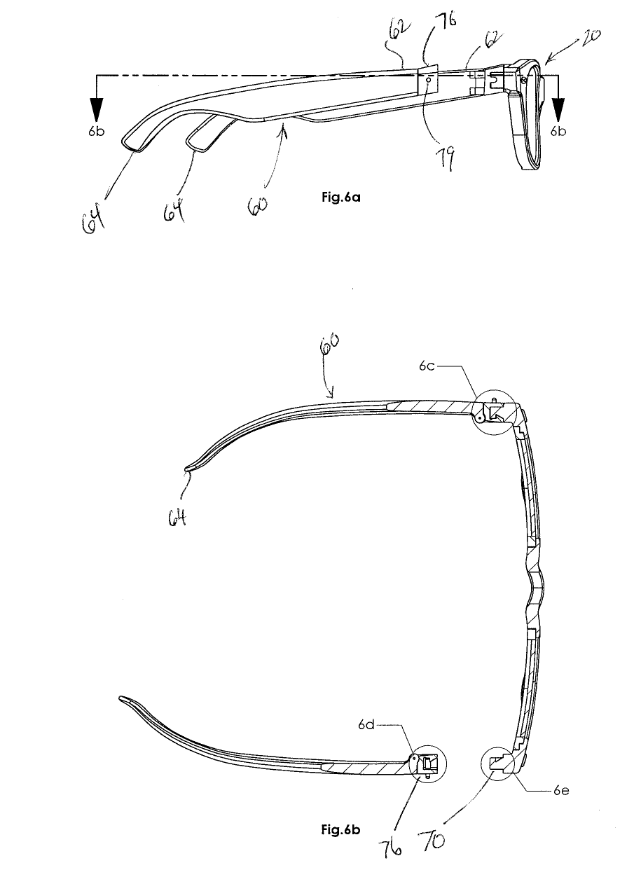

More particularly, a modular eyewear apparatus 10 according to a preferred embodiment of the present invention will now be described in detail with reference to FIGS. 1 to 6e of the present invention. The modular eyewear apparatus 10 includes a frame member 20 having a left socket portion 22 and a right socket portion 24 connected by a bridge portion 26. In one embodiment, the socket portions may have a generally circular rim defining an interior void although other configurations would also work. A temple connector 30 extends rearwardly from each respective rim of a respective socket portion.

The modular eyewear apparatus 10 further includes a lens holding member 50 having a pair of adjacent rim sections 52 removably and selectively coupled to the left and right socket portions 22, 24, respectively. Each lens holding member 50 is configured to hold actual eyewear lenses, such as lenses ground to a predetermined ophthalmic prescription, tinted lenses used as sunglasses, or the like. Means for coupling a lens holding member 50 to a frame member 20 will be described in further detail later.

In addition, the modular eyewear apparatus 10 includes a pair of temple members 60 selectively and removably coupled to the frame member 20. More particularly, each temple member 60 includes proximal 62 and distal 64 ends, the proximal end 62 being configured to operatively connect with a respective left or right socket 22, 24 such that respective temple members 60 are selectively interchangeable as described below.

In an embodiment, each temple member 60 is pivotally coupled to a respective left socket portion 22 or right socket portion 24, such as with a hinge, so as to be selectively movable between a folded-in configuration in which the temple member 60 is generally parallel and proximate to a frame member 20 and a folded-out configuration generally perpendicular and displaced from the frame member 20. In one embodiment, the pivotal movement of the temple members 60 is achieved by respective proximal ends 62 being pivotally coupled to respective temple connectors 30 with a hinge 65 or the like (FIG. 1b). In another embodiment (not shown), the temple connectors 30 themselves may be pivotally mounted to the frame member 20 with a hinge.

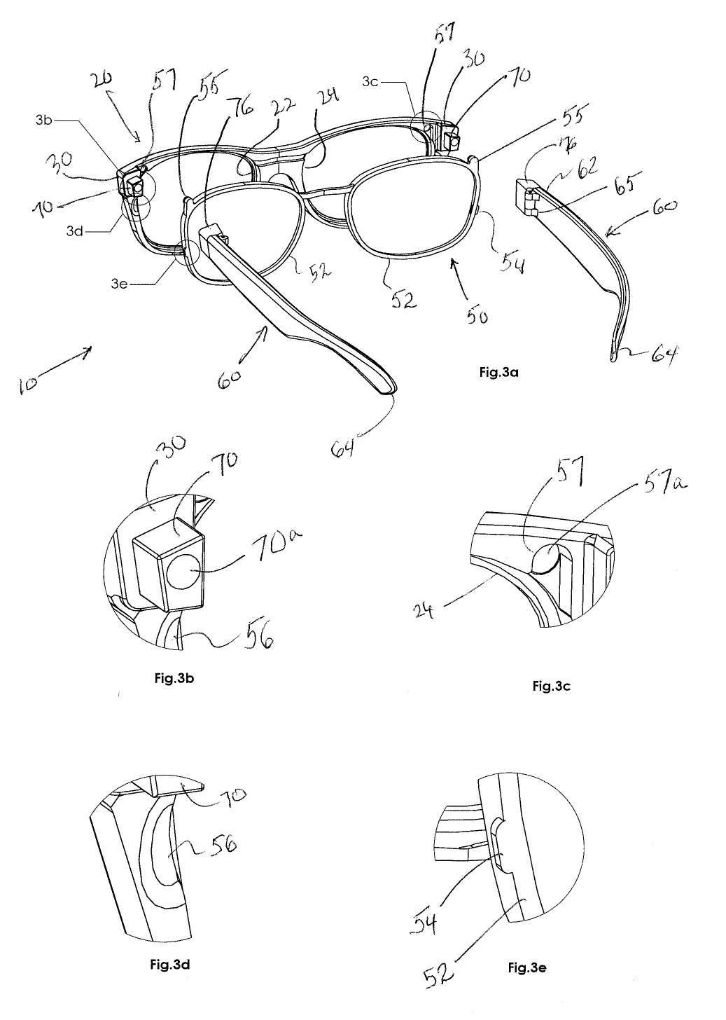

In an embodiment, each temple connector 30 includes a mounting flange 70 having a male shaped configuration extending rearwardly from a respective rim of each of the right socket portion 24 and the left socket portion 22 (FIG. 3a). Correspondingly, the proximal end 62 of a respective temple member 60 includes an auxiliary coupling member 76 defining an interior space and defining an open front in communication with the interior space. The open front and interior space of the auxiliary temple coupling member 76 are dimensioned and configured to receive a respective male mounting flange 70 of a respective temple connector 30 in a friction fit engagement. For enhanced engagement, the male end of a mounting flange 70 and the open end of an auxiliary temple coupling member 76 may include respective rare earth magnets 70a, 76a having opposite polarities so as to be magnetically attached to one another.

Further, the proximal end 62 of a respective temple member 60 according to this embodiment is pivotally coupled to a respective auxiliary coupling member 76 with a hinge 65, thus enabling the temple member 60 to move pivotally between a folded-in configuration at which a respective temple member 60 is generally parallel with and proximate to the frame member 20 and an extended-out configuration at which the respective temple member 60 is generally perpendicular to and displaced from the frame member 20.

In a variation of the embodiment described above, an auxiliary temple coupling member 76 may be removably coupled to a respective proximal end 62 of a temple member 60. It may be coupled in a friction fit manner or by corresponding hinge prongs coupled by a pin type fastener. In this arrangement, a temple member 60 may be directly connected to a frame member 20 without an intermediate auxiliary temple coupling member 76.

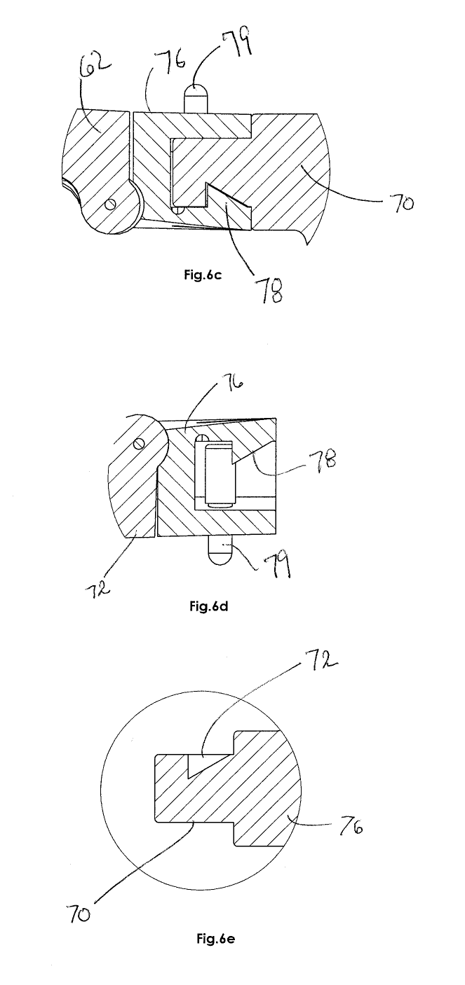

In an embodiment, respective temple members 60 may be coupled and released to the mounting flange 70 of a frame member 20 in a friction fit arrangement that is engaged or disengaged upon operation of an actuator button. More particularly, the male mounting flange 70 defines a notch 72 on one side while the auxiliary temple connecting member 76 includes a wedge 78 configured to selectively mate or nest with the notch 72 when the mounting flange 70 is received into the open front end and interior space of the auxiliary temple coupling member 76 (FIGS. 6c to 6e). In fact, the wedge 78 may be snappably received in the notch 72 in a locked configuration.

An actuator 79, such as a button or pin, may be movably mounted to the auxiliary temple coupling member 76 and extends into the interior area thereof. A user's depression of a respective actuator 79 causes a compression of the wedge 78 such that it is released from the notch 72 and allows the temple member 60 to be released from the respective mounting flange 70. Simply put, a temple member 60 is quickly released from a respective frame member 20 upon operation of a respective auxiliary temple coupling member 76.

In another embodiment (not shown), each temple member 60 includes a pair of nubs adjacent the proximal end thereof. Further, each temple connector defines an open interior area and an aperture in communication with and providing access to the interior area. It is understood that the interior area and aperture are dimensioned and configured to receive a respective proximal end of a temple member therein. Further, each temple connector 30 includes a pair of opposed walls each defining a recess configured to selectively receive a respective nub in a friction fit relationship. In use, a proximal end may be inserted into the interior area of a respective temple connector such that corresponding nubs and recesses are engaged so as to hold the temple member in place with the modular eyewear apparatus 10. If desired, the temple member 60 may be pulled away and the respective nub(s) is released from its friction fit engagement with a respective recess.

In an embodiment (not shown), each temple member 60 includes an actuator, such as a button and linkage connecting the button with the nubs that is configured to selectively move the nubs between retracted and extended configurations. More particularly, the nubs may be retracted into corresponding recesses when the actuator is operated and may be normally extended from the recesses when not actuated. In this regard, the nubs may be spring loaded to normally urge the nubs to the extended configuration. In use, operation of the actuator enables the proximal end 62 of a temple member 60 to be quickly released and removed from a corresponding temple connector 30.

In another embodiment (not shown), a proximal end 62 of each temple member 60 may include a jaw connector having upper and lower sections movable between open and closed configurations. As described above, each temple connector 30 may define an interior area configured to receive a proximal end 62 of a temple member 60. In this embodiment, a post having a flange at a free end thereof is positioned in the interior area of each temple connector. The jaw connector is operatively configured to surround and capture the flange when actuated to its open configuration and then released to its closed configuration. Conversely, the jaw connector may be selectively moved to the open configuration and then the temple member 60 pulled away from the temple connector, such as to remove, release, or interchange the temple member 60. In the manner described above, an actuator and suitable linkage may be operatively coupled to the jaw connector so as to move it between the open and closed configurations. In one embodiment, the jaw connector may be constructed of spring steel although other materials would also be suitable.

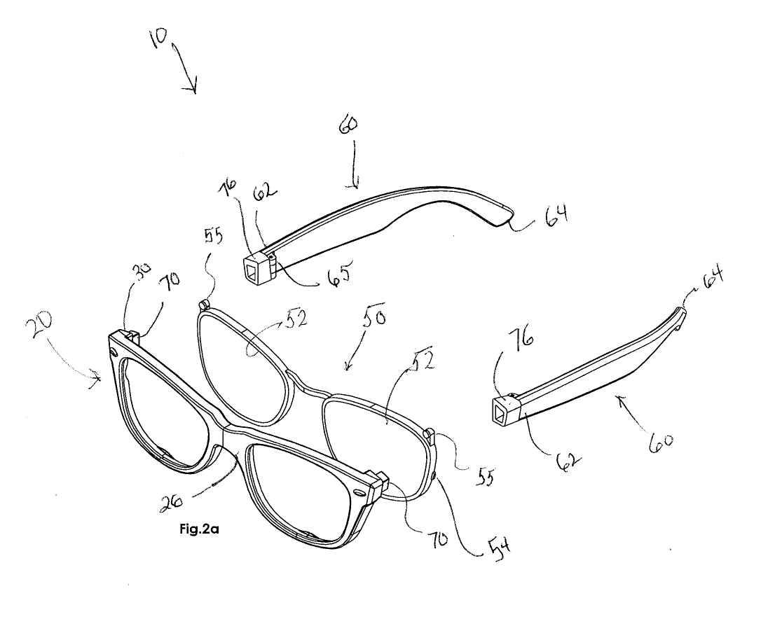

In another aspect, each rim section 52 of the lens holding member 50 includes at least one rim section fastener 54 extending away from the rim section 52 (FIG. 2a). Further, one rim section fastener 54 may extend upwardly from an upper surface of each adjacent rim section 52. Alternatively, one rim section fastener 54 may extend outwardly from respective side edges of each adjacent rim section 54 (FIG. 2a). Correspondingly, the left socket portion 22 and the right socket portion 24 define a receptor channel 56 in communication with a respective void described above. Each receptor channel 56 is dimensioned and configured to selectively receive a respective rim section fastener 54 in a friction fit arrangement such that each lens holding member 50 is selectively and releasably coupled to the frame member 20. A respective receptor channel 56, therefore, is positioned on an upper, lower, or side surface of a respective left or right socket portion so as to align and correspond with a position of a corresponding rim section fastener 54. Respective rim fasteners and channels may be held in a friction or snap fit arrangement for each coupling and separation as desired. It is understood that a rim section fastener 54 may also be referred to as a “tab”.

In an embodiment, a respective rim section fastener 54 is spring loaded and movable between a retracted configuration compressed toward a respective rim section 52 and an extended configuration extending away from a respective rim section 52. The rim section fastener 54 is normally biased toward the extended configuration. In use, the spring loaded construction allows respective rim section fasteners 54 to be quickly compressed during mounting of a lens holding member 50 to be positioned relative to a frame member 20 and then released to engage respective receptor channels 56 for secure engagement therewith.

In another arrangement, rim fasteners 54 extending upwardly from respective adjacent rim sections 52 may be referred to as upper rim section fasteners and fasteners extending downwardly from respective adjacent rim sections 52 may be referred to as lower rim section fasteners. Further, the frame member 20 may define corresponding upper and lower receptor channels. In this arrangement, the lens holding member 50 is more securely coupled to the frame member 20 in the manner described above. In still another arrangement, one or more rim section fasteners 54 may extend laterally and outwardly from respective side edges of respective rim sections 52 (FIG. 2a).

In an embodiment, a rim mounting member 55 is coupled to at least one rim section 52, such as an upper corner (FIG. 3a). Preferably, a rim mounting member 55 is attached to each adjacent rim section 52 of the lens holding member 50. Correspondingly, each of the left socket portion 22 and right socket portion 24 of the frame member 20 defines an auxiliary receptor 57 (FIG. 3a) dimensioned and configured to receive a respective rim mounting member 55 in a friction fit relationship. Similar in function to each combination of a rim section fastener 54 and a receptor channel 56 described above, a corresponding rim mounting member 55 and auxiliary receptor 57 enhance the engagement between the lens holding member 50 and frame member 20 while allowing separation thereof with mild pulling apart effort. In a variation of this embodiment, a rim mounting member 55 and/or auxiliary receptor 57 may include one or more rare earth magnets 55a, 57a to enhance the attachment.

In use, a frame member 20, a lens holding member 50, and one or more temple members 60 having personally desired configurations may be selected and selectively coupled together. The configurations of the selected members themselves enable them to be quickly and efficiently released from an assembly or to be arranged into a new assembly as described above.

It is understood that while certain forms of this invention have been illustrated and described, it is not limited thereto except insofar as such limitations are included in the following claims and allowable functional equivalents thereof.

1. A modular eyewear apparatus for wear on the head of a person, comprising:
a frame member having left and right socket portions each having a generally circular rim defining an interior void, respectively, and being connected by a bridge portion, said left and said right socket portions having a temple connector extending rearwardly from a respective rim;
a lens holding member having a pair of adjacent rim sections selectively coupled to said temple connectors of said left and said right socket portions, respectively; and
a pair of temple members having proximal and distal ends, respectively, each proximal end being selectively coupled to a respective temple connector such that said temple members are interchangeable.

2. The modular eyewear apparatus as in claim 1, wherein said temple members are pivotally connected to said left socket portion and said right socket portion, respectively, and selectively movable between a folded-in configuration at which a respective temple member is generally parallel and proximate to said frame member and an extended-out configuration at which said respective temple member is generally perpendicular to and displaced from said frame member.

3. The modular eyewear apparatus as in claim 1, wherein:
each temple connector includes a mounting flange having a male configuration extending rearwardly relative to a respective left or right socket member of said frame member;
said proximal end of each temple member includes an auxiliary coupling member defining an interior area and an open front in communication with said interior area, said open front and interior area being configured to selectively receive a respective mounting flange in a friction fit engagement

4. The modular eyewear apparatus as in claim 3, wherein said mounting flange and said auxiliary coupling member include magnets, respectively, having opposite magnetic polarities such that said mounting flange and said auxiliary coupling member are magnetically attracted to one another.

5. The modular eyewear apparatus as in claim 3, comprising an actuator operatively coupled to each auxiliary coupling member, each said actuator configured to selectively displace said mounting flange from said auxiliary coupling member.

6. The modular eyewear apparatus as in claim 5, wherein:
each respective mounting flange defines a notch;
each auxiliary connecting member includes a wedge selectively nested in said notch in a friction fit engagement such that a respective temple member is selectively coupled to said frame member; and
said actuator arranged to displace said wedge from said notch when actuated.

7. The modular eyewear apparatus as in claim 1, wherein:
each rim section of said lens holding member includes a rim section fastener extending away from said rim section, respectively;
said left and said right socket portions of said frame member define a receptor channel in communication with a respective interior void, a respective receptor void being configured to selectively receive a respective rim section fastener such that said lens holding member is selectively coupled to said frame member.

8. The modular eyewear apparatus as in claim 7, wherein each said respective rim section fastener is received into said respective receptor channel in a generally friction fit arrangement such that said lens holding member is removably coupled to said frame member.

9. The modular eyewear apparatus as in claim 7, wherein said respective rim section fastener is spring loaded and movable between a retracted configuration compressed toward said respective rim section and an extended configuration extending away from said respective rim section, each rim section fastener being normally biased toward said extended configuration.

10. The modular eyewear apparatus as in claim 9, wherein:
each rim section of said lens holding member includes a side rim section fastener extending away from a side edge of said rim section;
said left and said right socket portions of said frame member define a side receptor channel, respectively, in communication with a respective frame member interior void, a respective side receptor channel being configured to selectively receive a respective side rim section fastener in a generally friction fit arrangement such that said lens holding member is selectively coupled to said frame member.

11. The modular eyewear apparatus as in claim 3, wherein:
each rim section of said lens holding member includes a rim section fastener extending away from said rim section, respectively;
said left and said right socket portions of said frame member define a receptor channel in communication with a respective interior void, a respective receptor void being configured to selectively receive a respective rim section fastener such that said lens holding member is selectively coupled to said frame member.

12. The modular eyewear apparatus as in claim 11, wherein each said respective rim section fastener is received into said respective receptor channel in a generally friction fit arrangement such that said lens holding member is removably coupled to said frame member.

13. The modular eyewear apparatus as in claim 7, comprising an actuator operatively coupled to each auxiliary coupling member, each said actuator configured to selectively displace said mounting flange from said auxiliary coupling member.

14. The modular eyewear apparatus as in claim 7, wherein:
each respective mounting flange defines a notch;
each auxiliary connecting member includes a wedge selectively nested in said notch in a friction fit engagement such that a respective temple member is selectively coupled to said frame member; and
an actuator operatively coupled to each auxiliary coupling member and is configured to selectively displace said wedge from said notch when actuated.

15. The modular eyewear apparatus as in claim 14, wherein each said respective rim section fastener is received into said respective receptor channel in a generally friction fit arrangement such that said lens holding member is removably coupled to said frame member.

16. The modular eyewear apparatus as in claim 7, wherein:
a rim mounting member is attached to a respective rim section of said lens holding member;
at least one of said left socket portion or said right socket portion defines an auxiliary receptor having a configuration complementary to a configuration of said rim mounting member such that said rim mounting member is selectively received in said auxiliary receptor.

17. The modular eyewear apparatus as in claim 16, wherein said rim mounting member and said auxiliary receptor include magnets, respectively, having opposite magnetic polarities such that said mounting flange and said auxiliary coupling member are magnetically attracted to one another.

18. The modular eyewear apparatus as in claim 1, wherein:
a rim mounting member is attached to a respective rim section of said lens holding member;
at least one of said left socket portion or said right socket portion defines an auxiliary receptor having a configuration complementary to a configuration of said rim mounting member such that said rim mounting member is selectively received in said auxiliary receptor.

19. The modular eyewear apparatus as in claim 18, wherein said rim mounting member and said auxiliary receptor include magnets, respectively, having opposite magnetic polarities such that said mounting flange and said auxiliary coupling member are magnetically attracted to one another.
